(19) United States
(12) Patent Application Publication
(10) Pub. No.: US 2007/0031680 A1
(43) Pub. Date: Feb. 8, 2007

(54) Pitch resistant hot melt polyurethane

(76) Inventors: John Fromwiller, Cary, NC (US); Alyssa Brindel, Williamsburg, VA (US)

Correspondence Address: MYERS BIGEL SIBLEY & SAJOVEC, PO BOX 37428, RALEIGH, NC, 27627, US

(21) Appl. No.: 11/492,719

(22) Filed: Jul. 25, 2006

Related U.S. Application Data
(60) Provisional application No. 60/702,145, filed on Jul. 25, 2005.

(51) Int. Cl. B32B 27/40

(52) U.S. Cl. 428/423.1; 525/540

(57) ABSTRACT

The present invention relates to hot melt polyurethanes. The polyurethane can include a polyol and both a pure and polymeric polyisocyanate. Generally the polyurethane can be used to improve pitch resistance in building materials.

### CROSS-REFERENCE TO RELATED APPLICATION

This application claims priority to U.S. Provisional Application Ser. No. 60/702,145, filed Jul. 25, 2005, the disclosure of which is incorporated by reference in its entirety.

### FIELD OF INVENTION

The present invention relates to pitch resistant polyurethanes. Such polyurethanes can be used as a coating on a wide variety of substrates, such as plastic, metal and wood. The present invention also relates to methods for producing a hot melt polyurethane.

### BACKGROUND OF INVENTION

Wood members have long been used in the manufacture of building products. Examples of such building products include, but are not limited to, door jambs, end rails, stiles, rails, and compression molded door skins, interior and exterior trim products, pilasters, railings and posts, stairs, mull posts, dimensional members, thresholds, brickmould, ultra-light-, medium- or high-density fiberboard, oriented strand board, laminated strand lumber, laminated beams, plywood, particle board, and plastic wood. These wood members can be made from solid wood or fiber-based materials.

People appreciate these building products formed of wood members because of their relatively inexpensive cost, structural strength properties, and warm feel. However, building products formed of wood members are susceptible to damage due to exposure to water, moisture and sunlight. For instance, unprotected wood members weather relatively rapidly as soluble sugars are leached by water and scissioned by ultraviolet light in sunlight. Within two or three months, the surfaces of most wood members exposed to the weather are damaged sufficiently so as to be unpaintable.

Additionally, water insoluble extractives such as pitch and resin may also interfere with the appearance of a painted surface. In some species, small amounts of pitch form in the wood. In other species the pitch can form in large deposits called pitch pockets. If the wood is kiln dried at high temperature, the pitch can be hardened or set in the wood. Specific kiln schedules have been developed for many wood species to accomplish this. Unfortunately, some of these schedules also can discolor the surface of the wood. If pitch is not set, it can become fluid enough during periods of warm weather to flow to the surface of the wood. If the wood has been painted, the pitch tends to soften and discolor the paint. Young growth knotty siding products that have been air dried rather than kiln dried may be more prone to pitch bleeding. Young growth products will typically have smaller pitch pockets than those found in old growth. Additionally, knots of many softwood species contain an abundance of resin that can sometimes cause paint to turn yellow-brown over the knots. Primers formulated to block water soluble extractives will not block these resins.

Thus, there is a need to produce a polyurethane that can improve the properties of building products.

### SUMMARY OF INVENTION

The present invention includes methods of improving pitch resistance in a hot melt polyurethane by combining polyols, pure polyisocyanates and polymeric polyisocyanates.

The present invention also discloses methods of forming a flexible substrate on a wood surface by depositing a hot melt polyurethane on a wood surface, positioning a flexible substrate on the wood surface, and curing said hot melt polyurethane. The hot melt polyurethane includes a polyol, a pure polyisocyanate and a polymeric polyisocyanate.

The present invention also discloses methods for reducing pitch resistance in profile wrapping by depositing a hot melt polyurethane on a first substrate, wherein said hot melt polyurethane comprises a polyol, a pure polyisocyanate and a polymeric polyisocyanate, on a wood substrate; and then depositing a flexible substrate upon the hot melt polyurethane.

The polyols selected can be polyester polyols such as an aromatic polyester polyol, a crystalline polyester and/or a saturated polyester. The aromatic polyester polyol can include 1 to 20 percent of the hot melt polyurethane, the saturated polyester can include 1 to 50 percent by weight of the hot melt polyurethane, and the crystalline polyester can include 1 to 35 percent by weight of the hot melt polyurethane.

The pure polyisocyanate of the hot melt polyurethane can include 5 to 20 percent by weight of the hot melt polyurethane, while the polymeric polyisocyanate can include 8 to 20 percent by weight of the hot melt polyurethane.

### DETAILED DESCRIPTION OF INVENTION

The present invention will now be described more fully hereinafter in which preferred embodiments of the invention are provided. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

One aspect of the present invention relates to hot melt polyurethanes that are resistant to pitch. It is known in the field that water insoluble extractives such as pitch and resin can interfere with the appearance of a painted surface. In some species of wood, small amounts of pitch form in the wood. In other species of wood, the pitch can form in large deposits called pitch pockets. If the wood is kiln dried at high temperature, the pitch can be hardened or set in the wood.

The hot melt polyurethanes of the present application can be used for profile wrapping. Profile wrapping is an application where a flexible substrate such as vinyl or other veneer, is adhered around a solid substrate. The end result is a profile (or molding) with a surface different from the substrate. Solvent based, water based, and 100% solids hot melt adhesives can be used for this application. 100% solids hot melt adhesives can have a processing advantage because of the speed of the application and the fact that there are no volatiles to evaporate off. In more demanding profile wrapping applications where resistance to water and heat are needed, hot melt polyurethanes that moisture cure with water in the substrates and the surrounding air after application form a high strength durable thermoset bond.

Embodiments of the invention include methods of improving pitch resistance in a hot melt polyurethane comprising combining a polyol, a pure polyisocyanate and a polymeric polyisocyanate. The polyol can be a polyester. The polyester can be an aromatic polyester polyol, a crystalline polyester and/or a saturated polyester. The aromatic polyester polyol selected can be 1 to 20 percent of the hot melt polyurethane, while the saturated polyester can be 1 to 50 percent by weight of the hot melt polyurethane, and the crystalline polyester can be 1 to 35 percent by weight of the hot melt polyurethane.

The term “polyisocyanate” in the context of the present invention is understood to encompass difunctional isocyanate species, higher functionality isocyanate species, and mixtures thereof.

Organic polyisocyanates, or pure polyisocyanates, which may be used to practice the invention, include alkylene diisocyanates, cycloalkylene diisocyanates, aromatic diisocyanates and aliphatic-aromatic diisocyanates. Examples of such suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diis-ocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Although not wishing to be bound by any theory, it is suspected that the preferred isocyanate-containing compounds are methylenebisphenyldiisocyanate (MDI), isophoronediisocyanate (IPDI), hydrogenated methylenebisphenyldiisocyanate (HMDI) and toluene diisocyanate (TDI). In general, aromatic polyisocyanates are preferred. Although not wishing to be bound by any theory, it is suspected that the most preferred aromatic polyisocyanates are 4,4′-MDI, 2,4′-MDI, polymeric MDI, MDI variants, and mixtures of these. Isocyanate terminated prepolymers may also be employed. The pure polyisocyanate can be 5 to 20 percent by weight of the hot melt polyurethane.

The second polyisocyanate component suitable for preparing the hot melt polyurethane includes a polymeric polyisocyanate. Commercially available polymeric polyisocyanates of the MDI series include RUBINATE™ M polyisocyanate, which is commercially available from Huntsman Polyurethanes. RUBFNATE™ M polyisocyanate is a base polyisocyanate comprising a complex mixture of MDI diisocyanate isomers and higher functionality oligomers of the MDI series. This commercial base polyisocyanate product has a free—NCO content of about 31.5% by weight and a number averaged functionality of about 2.7. The polymeric polyisocyanate can be 8 to 20 percent by weight of the hot melt polyurethane.

As noted above, the ingredients used to prepare the polyisocyanate wood adhesive also include one or more polyols. The polyol can be a polyether or polyester polyol. A “polyether polyol” is understood to be a linear polyether containing predominantly two OH groups. The preferred polyether polyols are diols corresponding to the general formula HO(—R—O)ₘ—H, where R is a hydrocarbon radical containing 2 to 4 carbon atoms and m is in the range from 4 to 225 on average. Some examples of such polyether polyols include polyethylene glycol, polybutylene glycol, polytetramethylene glycol (polyTHF) and polypropylene glycol (R═—CH₂ CH(CH₃)—). Such polyether polyols may be prepared by known methods such as, for example, polymerization of one or more cyclic ether monomers such as ethylene oxide, propylene oxide, n-butene oxide, and tetrahydrofuran. The polyether polyols may be used both as homopolymers and as copolymers, both as block copolymers and as statistical (random) copolymers. Only one type of polyether polyol is generally used, although mixtures of 2 to 3 polyether polyols differing in their average molecular weight and/or in the nature of their structural elements may also be used. Small quantities of a trifunctional polyether polyol (i.e., a polyether triol) may also be present in the mixture.

A “polyester polyol” is understood to be a polyester having more than one hydroxyl group, generally two terminal hydroxyl groups. Preparation is by known routes, either from
a) aliphatic hydroxycarboxylic acids, or from
b) aliphatic and/or aromatic dicarboxylic acids having from 6 to 12 carbon atoms and—particularly even-numbered—diols having from 4 to 8 carbon atoms.

Of course, other appropriate derivatives may be used, including, for example, lactones, methyl esters or anhydrides. Specific starting materials include: 1,4-butanediol, 1,6-hexanediol, 1,10-decanediol, 1,12-dodecanediol, adipic, azelaic and sebacic acids, 1,10-decanedicarboxylic acid and lactones. The acid component may include up to 25% on a molar basis of other acids, for example, cyclohexanedicarboxylic acid, terephthalic acid and isophthalic acid. The glycol component may include up to 15% on a molar basis of other diols, for example, diethylene glycol and 1,4-cyclohexanedimethanol. In addition to homopolymers from the above components, above all, copolyesters from the following components or derivatives thereof are of importance:
1. adipic acid, isophthalic acid, phthalic acid, and butanediol;
2. adipic acid, phthalic acid and hexanediol;
3. adipic acid, isophthalic acid, phthalic acid, ethylene glycol, neopentylglycol, and 3-hydroxy-2,2-dimethylpropyl-3-hydroxy-2,2-dimethyl propanoate;
4. adipic acid, phthalic acid, neopentylglycol, and ethylene glycol; and
5. adipic acid and hexanediol.

The copolyester from adipic acid, isophthalic acid, phthalic acid, and butanediol is partially crystalline and has a high viscosity. Hence, it results in high initial strength. The copolyester from adipic acid, phthalic acid and hexanediol has low glass transition temperature and therefore, results in improved low-temperature flexibility.

The suitable polyester polyols may optionally be lightly branched, i.e. small quantities of a tricarboxylic acid or trihydric alcohol have been used in their production.

The polyols can include amine-initiated polyols. When polyols are used in the raw material stream, they can incorporated into the final polyisocyanate composition by prepolymerization with a molar excess of the base polyisocyanate. The prepolymer species, optional in this invention, are isocyanate terminated. The formation of isocyanate terminated prepolymers is well known in the art.

The polyester polyols can be either liquids or solids. In the case where they are solid, they are preferably amorphous. However, they can be weakly crystalline as well. Generally, a mixture of partially crystalline and amorphous polyesters is employed. However, crystallinity is developed so weakly that it does not become noticeable as opaqueness in the final hot-melt polyurethane.

The hot polyurethane can also include other optional components. One such component could be a stabilizer. “Stabilizers” in the context of the present invention include stabilizers that stabilize the viscosity of the polyurethane prepolymer during its production, storage and application. Suitable stabilizers of this type include, for example, monofunctional carboxylic acid chlorides, monofunctional highly reactive isocyanates and non-corrosive inorganic acids. Examples of such stabilizers are benzoyl chloride, toluene sulfonyl isocyanate, phosphoric acid or phosphorous acid. In addition, stabilizers in the context of the present invention include antioxidants, UV stabilizers or hydrolysis stabilizers. The choice of these stabilizers is determined on the one hand by the main components of the polyurethane and on the other hand by the application conditions and by the loads to which the bond is likely to be exposed. When the polyurethane prepolymer is predominantly made up of polyether units, antioxidants—optionally in combination with UV stabilizers—are mainly necessary. Examples of suitable antioxidants include the commercially available sterically hindered phenols and/or thioethers and/or substituted benzotriazoles.

Other examples include suitable tackifying resins which can include abietic acid, abietic acid esters, terpene resins, terpene/phenol resins or hydrocarbon resins. Tackifying resin(s) may be incorporated into the adhesive composition to improve the tack and to impart pressure sensitive qualities of the adhesive composition, if desirable. Tackifying resins may be selected based on their compatibility with the composition.

Examples for fillers include silicates, talcum, calcium carbonates, clays or carbon black, silicas, urea derivatives and fibrillated or pulp chopped fibers and combinations thereof. Some commercially available useful fillers include talc available under the tradename Mistron Vapor from Luzenac America, Inc. (Englewood, Col.); different particle size grades of talc available under the tradename Nytal™ 200, 300 and 400 from R. T. Vanderbilt Co. (Norwalk, Conn.); Kaolin clay available under the tradename Snobrite™ Clay from Evans Clay Co. (Mcintyre, Ga.); fumed silica available under the tradename Cab-o-Si™ TD-720 from Cabot Corp. (Tuscol, Ill.); and 3× and 4× micas available under the tradename Mineralite™ from Mineral Mining Corp. (Kershaw, S.C.).

Although frequently no additional adhesion promoters are required, the above mentioned tackifying resins like abietic acid, terpene resins, terpene/phenol resins or hydrocarbon resins can also act as adhesive promoters. In some cases organofunctional silanes like the epoxy functional 3-glycidyl-oxypropyl-trialkoxysilane or the isocyanatefunctional isocyanatoethyl trisalkoxysilane, epoxy resins, melamine resins or phenolic resins may be added as adhesion promoters.

Another additive can include UV absorbers which improve the weather resistance of the polyurethane top coat. The UV absorbers generally recognized in the art may be suitable for use with the invention. Alternatively, a hindered amine radical scavenger can be included in the first reaction component or combined with an UV absorber. The hindered amine free radical scavengers generally recognized in the art contribute to photostabilization of the polyurethane by trapping alkoxy and hydroxy radicals produced by light-induced dissociation of hydroperoxides. The amount of UV absorber can range from about 0.01 weight percent to about 5 weight percent. The amount of hindered amine radical scavenger in the first component in desirably in the range of about 0.01 weight percent to about 2 weight percent.

Additionally, moisture scavengers, antioxidants, and antifoaming agents can be included. Conventional compounds of the noted categories generally recognized by those skilled in the art may be suitable for use in the present invention to improve the finished properties of the polyurethane. Moisture scavengers are desirably included at levels in the range of about 0.01 weight percent to about 5 weight percent. The antioxidant is desirably included in a range of about 0.01 weight percent to about 5 weight percent. Antifoaming agents are desirably included in an amount from about 0.5 weight percent or less.

Other compounds, such as coloring agents and decorative solids, can be added to the composition to enhance to the aesthetics of the finished polyurethane. Coloring agents, such as pigments or dyes, are included at various levels to obtain a desired effect. Decorative solids could include such items as metal flakes, polymeric flakes, glitter, beads, or other materials that provide a decorative feature to the finished polyurethane. The decorative solids are also included in various amounts to obtain a desired effect to the finished article.

The ingredients incorporated into the hot melt polyurethane disclosed herein may optionally include an antioxidant.

The hot melt polyurethane can also provide a proper open time. The hot melt polyurethane can also provide proper green strength including the ability of an incompletely cured material to undergo removal from the mold and handling without distortion.

Embodiments of the present invention include methods for reducing pitch resistance in profile wrapping comprising depositing a hot melt polyurethane, wherein said hot melt polyurethane comprises a polyol, a pure polyisocyanate and a polymeric polyisocyanate, on a wood substrate; and depositing a flexible substrate upon the hot melt polyurethane.

Embodiments of the present invention include methods of forming a flexible substrate on a wood surface by depositing a hot melt polyurethane on a wood surface; positioning a flexible substrate on the wood surface; and curing said hot melt polyurethane, wherein said hot melt polyurethane comprises combining a polyol, a pure polyisocyanate and a polymeric polyisocyanate. The curing can include a moisture cure. The flexible substrate can include vinyl and can be used as a profile warp.

The polyurethane hotmelt adhesive composition according to this invention can be prepared utilizing the following components. Stepanpol PH-56, a ortho phtalate-1,6,hexanediol based aromatic, a polyester poylol such as 1,3-isobenxofurandione, polymer with 1,6 hexanediol, Dynacoll 7380, a crystalline polyester, Dynacoll 7331, a saturated polyester, Rubinate 1225, a pure diphenylmethane diisocyanate, Rubinate 1820, a polymeric MDI diphenylmethane diisocyanate, and an antioxidant such as Clarinol G80. These components may be used in numerous ranges. For example, the aromatic polyester polyol selected can be 1 to 10 percent of the hot melt polyurethane, while the saturated polyester can be 1 to 50 percent by weight of the hot melt polyurethane, and the crystalline polyester can be 1 to 35 percent by weight of the hot melt polyurethane. The antioxidant can be 0 to 25 percent by weight of the hot melt polyurethane.

Having now described the invention, the same will be illustrated with reference to certain examples, which are included herein for illustration purposes only, and which are not intended to be limiting of the invention.

### EXAMPLES

A hot melt polyurethane composition was produced using 7.9% Stepanol PH-56, 29.9% Dynacoll 7380, 42.1% Dynacoll 7331, 11.4% Rubinate 1225, 8.5% Rubinate Rubinate 1820. Other compositions were produced changing the percentages of the components. Additional compositions were produced with alterations to the percentages of the components to either 1) include an antioxidant; 2) replace Rubinate 1225 with Mondur M; or 3) both. Further compositions were produced utilizing an aromatic diisocyante in place of the Rubinate 1225 and Rubinate 1820.

Acid hydrolysis Screening for Adhesives

A pitch resistance test was performed to determine the susceptibility of an adhesive to undergo acid hydrolysis when in contact with wood resins and moisture. The samples were set up utilizing approximately ten grams of adhesive placed in glass vials containing tall oil and water. The glass vials were sealed with polyethylene lined caps. The vials were all rolled slowly to wet the adhesive strip which was coated to be tested on wax paper. The vials were then sealed and placed into a 70° C. oven. Periodically, at least every other day, the vials were removed from the oven and checked for a) visible breakdown of the adhesive strips; b) visible weakening of the adhesive by trying to pry a portion of the adhesive film from the rest of the strip; and c) visible deterioration of the adhesive by grasping the strip while hot with a forceps and attempting to move the strip. A hot melt polyurethane comprising a polyol, a pure polyisocyanate and a polymeric polyisocyanate passed this test.

Tall Oil Soak of Tensile Films

The tensile strength of the hot melt polyurethane was tested using a tall oil soak. The tall oil soak simulates pitch. First, vials were filled utilizing a tall oil. (Arizona Chemical Sylcatal D40LR). The study included both control, heat only, and tall oil soak samples. The tall oil soak samples and heat only samples were tested throughout twenty-one days in an oven at 70° C. (158° F.) and prodded and tugged on with a tweezers to determine if the adhesive film has softened or deteriorated significantly. The A hot melt polyurethane comprising a polyol, a pure polyisocyanate and a polymeric polyisocyanate passed this test held their shape and did not break apart or separate when pulled by a tweezer or prodded with a stick. Furthermore, the composition comprising a polyol, a pure polyisocyanate and a polymeric polyisocyanate passed this test. More specifically, the composition comprising both Rubinate 1225 and Rubinate 1820 illustrated a 63.9% strength retention in the tall oil soak.

Boil Resistance

Vinyl was wrapped to a wood substrate and boiled for a six hour period. The samples were than allowed to dry and were peeled at 90°. The compositions were then peeled to determine water resistance. The tests indicated that a hot melt polyurethane comprising a polyol, a pure polyisocyanate and a polymeric polyisocyanate passed this test.

The foregoing examples are illustrative of the present invention and are not to be construed as limiting thereof. The invention is defined by the following claims, with equivalents of the claims to be included therein.

What is claimed:

1. A method of improving pitch resistance in a hot melt polyurethane comprising:
combining a polyol, a pure polyisocyanate and a polymeric polyisocyanate.

2. The method according to claim 1, wherein the polyol is selected from the group consisting of a polyester and a polyether.

3. The method according to claim 2, wherein the polyester is an aromatic polyester polyol, a crystalline polyester and/or a saturated polyester.

4. The method according to claim 3, wherein the aromatic polyester polyol comprises 1 to 20 percent of the hot melt polyurethane, the saturated polyester comprises 1 to 50 percent by weight of the hot melt polyurethane, and the crystalline polyester comprises 1 to 35 percent by weight of the hot melt polyurethane.

5. The method according to claim 1, wherein the pure polyisocyanate is 5 to 20 percent by weight of the hot melt polyurethane.

6. The method according to claim 1, wherein the polymeric polyisocyanate is 8 to 20 percent by weight of the hot melt polyurethane.

7. The method according to claim 1, wherein the hot melt polyurethane further comprises an antioxidant.

8. A method for reducing pitch resistance in profile wrapping comprising:
depositing a hot melt polyurethane on a first substrate, wherein said hot melt polyurethane comprises a polyol, a pure polyisocyanate and a polymeric polyisocyanate, on a wood substrate; and
depositing a flexible substrate upon the hot melt polyurethane.

9. The method according to claim 8, wherein the polyol is selected from the group consisting of a polyester and a polyether.

10. The method according to claim 9, wherein the polyester is an aromatic polyester polyol, a crystalline polyester and/or a saturated polyester.

11. The method according to claim 8, wherein the aromatic polyester polyol comprises 1 to 20 percent of the hot melt polyurethane, the saturated polyester comprises 1 to 50 percent by weight of the hot melt polyurethane, and the crystalline polyester comprises 1 to 35 percent by weight of the hot melt polyurethane.

12. The method according to claim 8, wherein the pure polyisocyanate is 5 to 20 percent by weight of the hot melt polyurethane.

13. The method according to claim 8, wherein the polymeric polyisocyanate is 8 to 20 percent by weight of the hot melt polyurethane.

14. The method according to claim 8, wherein the hot melt polyurethane further comprises an antioxidant.

15. A method of forming a flexible substrate on a wood surface comprising:
depositing a hot melt polyurethane on a wood surface;
positioning a flexible substrate on the wood surface; and
curing said hot melt polyurethane,
wherein said hot melt polyurethane comprises combining a polyol, a pure polyisocyanate and a polymeric polyisocyanate.

16. The method according to claim 15, wherein said curing is a moisture cure.

17. The method according to claim 15, wherein said flexible substrate is vinyl.

18. The method according to claim 15, wherein said flexible substrate is a profile wrap.

19. The method according to claim 15, wherein the polyol is selected from the group consisting of a polyester and a polyether.

20. The method according to claim 19, wherein the polyester is an aromatic polyester polyol, a crystalline polyester and/or a saturated polyester.

21. The method according to claim 20, wherein the aromatic polyester polyol comprises 1 to 20 percent of the hot melt polyurethane, the saturated polyester comprises 1 to 50 percent by weight of the hot melt polyurethane, and the crystalline polyester comprises 1 to 35 percent by weight of the hot melt polyurethane

22. The method according to claim 15, wherein the pure polyisocyanate is 5 to 20 percent by weight of the hot melt polyurethane.

23. The method according to claim 15, wherein the polymeric polyisocyanate is 8 to 20 percent by weight of the hot melt polyurethane.

24. The method according to claim 15, wherein the hot melt polyurethane further comprises an antioxidant.
